(19) United States
(12) Patent Application Publication
(10) Pub. No.: US 2015/0030753 A1
(43) Pub. Date: Jan. 29, 2015

(54) Almond Pâté

(71) Applicant: Maria de las Nieves Cabeza, Carpinteria, CA (US)

(72) Inventor: Maria de las Nieves Cabeza, Carpinteria, CA (US)

(21) Appl. No.: 14/339,456

(22) Filed: Oct. 6, 2014

Related U.S. Application Data
(60) Provisional application No. 61/958,311, filed on Jul. 25, 2013.

(51) Int. Cl. A23L 1/36

(52) U.S. Cl. CPC A23L 1/366; A23V 2002/00
USPC 426/633

(57) ABSTRACT

The invention discloses a vegan Almond Pâté made with almonds, olives, vinegar, water, oil, garlic, white pepper, and black pepper. This invention provides a healthy and delicious alternative with very similar consistency and satiety factor as traditional liver pate.

### CROSS REFERENCE TO RELATED APPLICATION

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF INVENTION

Traditional liver pate is a cultural appetizer and snack enjoyed by people around the world. However, because it contains meat, many people cannot eat it. Up until now there has not been an alternative with similar consistency and satiety factor.

### BRIEF SUMMARY OF INVENTION

This product is a vegetarian, vegan and healthy pate spread. I grew up in Argentina where traditional liver pate is widely produced and consumed. When I became a vegetarian I began experimenting with vegetarian creations that substituted pate both in texture and flavor. After years of refining my technique and recipes I developed Almond Pâté. What distinguishes this product is that our unique process and preparation captures the flavors, textures and gastronomical experience of traditional liver pate spreads while using healthy and vegan ingredients. The flavor profile of this product enables it to be a suitable meatless substitute for traditional pates in any traditional meal, such as pate on crackers paired with wine, and also results in a similar satisfying filling experience after consumption.

### BRIEF DESCRIPTION OF THE SEVERAL VIEWS OF THE DRAWING

Not Applicable

### DETAILED DESCRIPTION OF INVENTION

My unique process begins with soaking the almonds for at least 24 hours or more in water and citric acid. This allows the almonds to swell, soften and sprout. Then they are drained and rinsed of impurities with clean fresh water and air-dried. When partially dried, they are salted and mixed with olives, fresh ground pepper, garlic and vinegars following the recipe I developed over time. The recipe is subject to small modifications in order to ensure consistency of flavor, texture and balance. This is because raw ingredients can vary in character because of natural and environmental factors or because they may be purchased from different sources. Without stirring ingredients I sprinkle powdered dried dates. After this, a period of maceration begins, and the almonds are infused with flavor. The final step is to grind the ingredients to a critical viscosity and texture that resembles traditional duck liver pate. To achieve this, oils are added towards the end of the grinding process.

Composition of matter:

1 part almonds, between 1/3 and 1/2 part olives, between 1/5 and 1/4 part vinegar, between 1/5 and 1/4 part water, between 1/8 and 1/7 part oil, between 1/40 and 1/20 part garlic, between 1/100 and 1/90 part white pepper, between 1/100 and 1/90 part black pepper, between 1/120 and 1/100 part powdered dry dates.

1. Almond Pâté, comprising of the following composition of matter:
1 part almonds, between 1/3 and 1/2 part olives, between 1/5 and 1/4 part vinegar, between 1/5 and 1/4 part water, between 1/8 and 1/7 part oil, between 1/40 and 1/20 part garlic, between 1/100 and 1/90 part white pepper, between 1/100 and 1/90 part black pepper, between 1/120 and 1/100 part powdered dry dates.

2. Almond Pâté, comprising of the following process for making the product:
Soak almonds for at least 24 hours in water and citric acid
Drain and rinse with filtered water at least two times during this period
Let almonds air dry but not completely
When partially dry, put almonds in a bowl and add additional ingredients stated in claim 1.
Let sit for a while
Grind all the ingredients. Allow time in between to infuse flavor.
Add oil to the processed ingredients and process a bit more for ideal consistency
